(19) United States
(12) Patent Application Publication
(10) Pub. No.: US 2019/0352924 A1
(43) Pub. Date: Nov. 21, 2019

(54) VEHICLE ROOFTOP BOX WITH HONEYCOMB CONSTRUCTION

(71) Applicant: Thule, Inc., Seymour, CT (US)

(72) Inventor: Evan CURRID, Santa Cruz, CA (US)

(21) Appl. No.: 16/415,214

(22) Filed: May 17, 2019

Related U.S. Application Data
(60) Provisional application No. 62/672,623, filed on May 17, 2018.

(51) Int. Cl. E04H 15/44; B60P 3/39; B60P 3/34; E04H 15/06; E04H 15/54

(52) U.S. Cl. CPC E04H 15/44; B60P 3/39; E04H 15/54; E04H 15/06; B60P 3/341

(57) ABSTRACT

A tent system includes a first shell member and a second shell member. The first shell member is configured to mount to a roof of a vehicle. The first shell member includes a honeycomb assembly. The honeycomb assembly includes a honeycomb core disposed between a first skin and a second skin. The first and second skins are coupled to opposing faces of the honeycomb core. The second shell member is configured to couple with the first shell member. The first and second shell members define an interior cavity in a closed configuration.

### CROSS REFERENCE TO RELATED APPLICATIONS

This application claims priority to U.S. Provisional Application No. 62/672,623, filed May 17, 2018, which is hereby incorporated herein in its entirety by reference.

### BACKGROUND

The present disclosure relates to tents, cargo boxes, and other containers. In some instances, the present disclosure relates to roof-top tents, cargo boxes, and other containers that are mountable to a roof of a vehicle.

Many outdoors enthusiasts enjoy camping, but setting up a tent can be time consuming and inconvenient, especially when there are no suitable places to put a tent. Additionally, it is frequently beneficial to be located off the ground to avoid disturbing or being disturbed by wildlife. One solution to such a problem is a roof-top tent that attaches to the top of a vehicle. Unfortunately, current roof-top tents also present various shortcomings. Existing rooftop tents and cargo boxes present various shortcoming including complex construction, heavy weight, and insufficient strength, among other shortcomings.

Some existing rooftop tents use a frame and foam construction to provide a rigid surface, however, such constructions may be difficult to build, expensive, environmentally detrimental, heavy, and lack sufficient rigidity. Similarly, some existing rooftop tents and cargo use lightweight materials, which are not sufficiently rigid, so they are reinforced using corrugations, ridges, or additional frames leading to more complexity, weight, wasted material, and expense in their construction.

Accordingly, there is a need among such tents to provide a tent or cargo system which addresses these shortcomings.

### BRIEF SUMMARY

In some embodiments, a tent system includes a first shell member and a second shell member. In some embodiments, the first shell member is configured to mount to a roof of a vehicle. In some embodiments, the first shell member includes a honeycomb assembly. In some embodiments, the honeycomb assembly includes a honeycomb core disposed between a first skin and a second skin. In some embodiments, the first and second skins are coupled to opposing faces of the honeycomb core. In some embodiments, the second shell member is configured to couple with the first shell member. In some embodiments, the first and second shell members define an interior cavity in a closed configuration.

In some embodiments, the first shell member includes acrylonitrile butadiene styrene (ABS). In some embodiments, the honeycomb core includes polypropylene. In some embodiments, the honeycomb core includes a plurality of cells. In some embodiments, the honeycomb core includes a plurality of cylindrical cavities. In some embodiments, the tent system further includes a flexible membrane coupled between the first and second shell members.

In some embodiments, the first and second skins comprise fiberglass. In some embodiments, the first skin includes a plurality of layers. In some embodiments, at least one layer comprises a metal sheet. In some embodiments, the metal sheet is aluminum. In some embodiments, the honeycomb assembly includes a thickness of 0.25 to 1 inch.

In some embodiments, the second shell member includes a second honeycomb assembly. In some embodiments, the second honeycomb assembly includes a second honeycomb core disposed between a third skin and a fourth skin. In some embodiments, the third and fourth skins are coupled to opposing faces of the second honeycomb core.

In some embodiments, the second shell member is configured to detach from the first shell member in an open configuration. In some embodiments, the first and second shell members are hinged. In some embodiments, the second shell member includes acrylonitrile butadiene styrene (ABS). In some embodiments, the tent system further includes a mounting frame disposed below the honeycomb assembly. In some embodiments, the mounting frame is configured to reinforce coupling of the first shell member to the vehicle. In some embodiments, the mounting frame is below a bottom surface of the first shell member.

In some embodiments, a tent system includes a base and a tent canopy. In some embodiments, the base is configured to mount to a roof of a vehicle. In some embodiments, the base includes a platform with a perimeter edge. In some embodiments, the platform includes a honeycomb assembly. In some embodiments, the honeycomb assembly includes a honeycomb core disposed between a first skin and a second skin. In some embodiments, the first and second skins are coupled to opposing faces of the honeycomb core. In some embodiments, the tent canopy is coupled to the perimeter edge of the platform.

In some embodiments, the honeycomb core includes polypropylene. In some embodiments, the first and second skins include fiberglass. In some embodiments, the platform includes a first rigid surface and a second rigid surface. In some embodiments, the first and second rigid surfaces are coupled to each other by a hinge. In some embodiments, the tent system further includes a tent frame coupled to the base and configured to support the tent canopy.

In some embodiments, a container system includes a first shell member and a second shell member. In some embodiments, the first shell member is configured to mount to a roof of a vehicle. In some embodiments, the first shell member includes a honeycomb assembly. In some embodiments, the honeycomb assembly includes a honeycomb core disposed between a first skin and a second skin. In some embodiments, the first and second skins are coupled to opposing faces of the honeycomb core. In some embodiments, the second shell member is configured to couple to the first shell member. In some embodiments, the second shell member includes a second honeycomb assembly. In some embodiments, the second honeycomb assembly includes a second honeycomb core disposed between a third skin and a fourth skin. In some embodiments, the third and fourth skins are coupled to opposing faces of the second honeycomb core. In some embodiments, the first and second shell members define an interior cavity in a closed configuration. In some embodiments, the first and second shell members include acrylonitrile butadiene styrene (ABS).

In some embodiments, the first and second honeycomb cores include polypropylene. In some embodiments, the first, second, third, and fourth skins comprise fiberglass.

### BRIEF DESCRIPTION OF THE DRAWINGS

The disclosure is illustrated by way of example, and not by way of limitation, in the figures of the accompanying drawings in which like reference numerals are used to refer to similar elements.

FIG. 1A is a side view of an example embodiment of a container system, according to the present disclosure, in an open position.

FIG. 1B is a side view of an example embodiment of a container system, according to the present disclosure, in a closed position.

FIG. 1C is a side view of an example embodiment of a container system, according to the present disclosure, in a closed position.

FIG. 1D is a perspective view of an example embodiment of a container system, according to the present disclosure, in an open position.

FIG. 2A is a perspective view of an example embodiment of a base system of a container system, according to the present disclosure, in an open position.

FIG. 2B is a perspective view of an example embodiment of a base system of a container system, according to the present disclosure, in a closed position.

FIG. 2C is a top-down perspective view of an example embodiment of a container system, according to the present disclosure, in an open position.

FIG. 2D is a bottom-up perspective view of an example embodiment of a container system, according to the present disclosure, in a closed position.

FIG. 2E is a perspective view of an example embodiment of a container system, according to the present disclosure, in an open position.

FIG. 3 is a view of an example embodiment of a cross section of honeycomb construction, according to some embodiments of the present disclosure.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

For the purposes of this disclosure, reference numbers may be used to refer to components found in any of the figures, regardless whether those reference numbers are shown in the figure being described. Further, where a reference number includes a letter referring to one of multiple similar components (e.g., component 000a, 000b, and 000n), the reference number may be used without the letter to refer to one or all of the similar components.

The present disclosure describes an innovative technology relating to a container system 102, for example, the disclosure may relate to a vehicle rooftop tent and/or cargo box using honeycomb sandwich construction. In some embodiments, the technology uses a honeycomb material to provide rigidity and/or support to one or more portions of the container system 102.

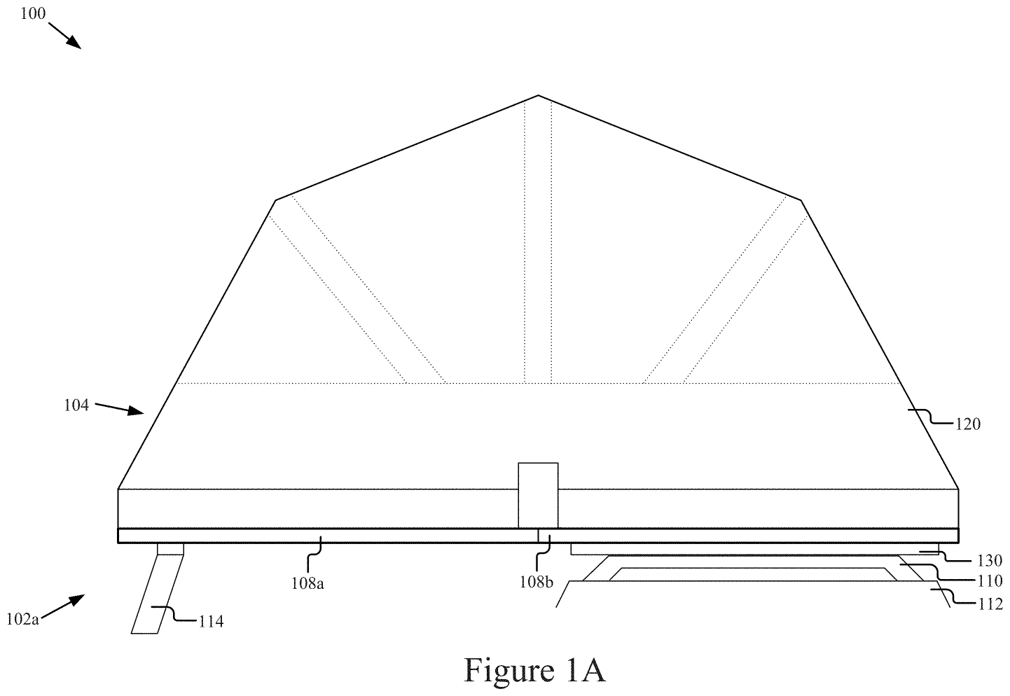

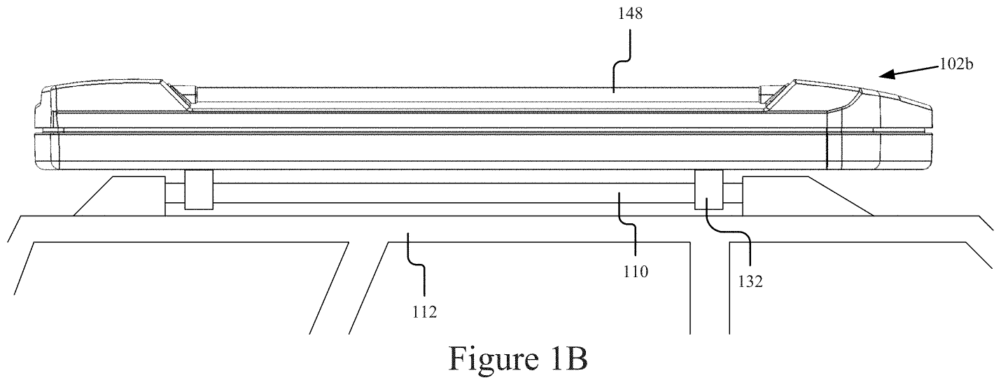

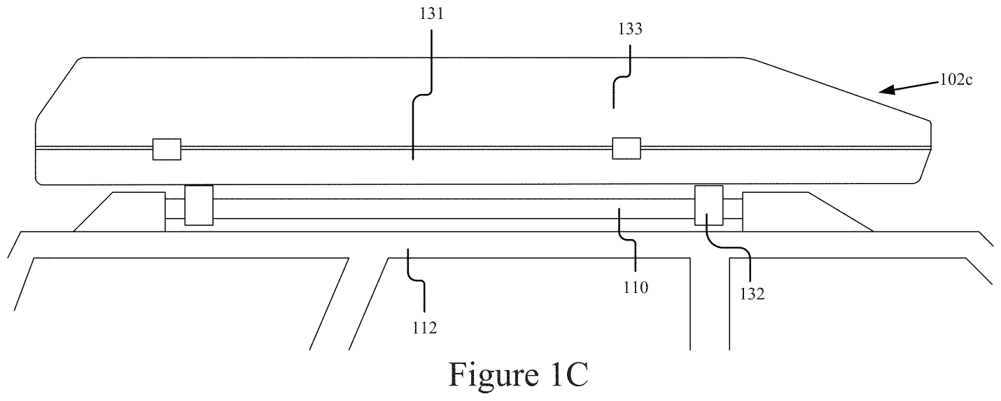

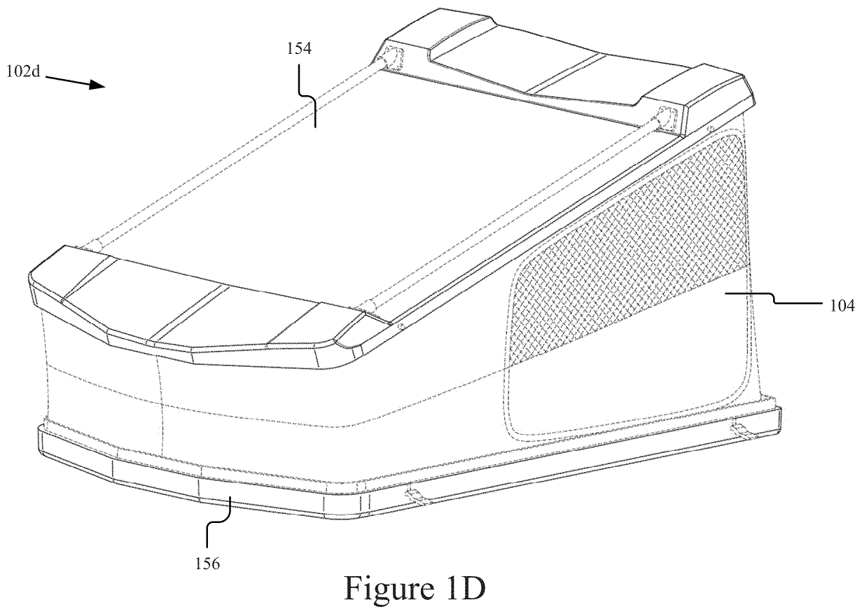

In some embodiments, the container system 102 may include a roof-top tent system including a hard-shell (e.g., as illustrated in FIG. 1D and/or 1B) or a softshell with a rigid base (e.g., as illustrated in FIG. 1A). In some embodiments, the container system 102 may include a roof-top cargo box (e.g., as illustrated in FIG. 1B and/or 1C). It should be noted that although the container system is described herein in relation to embodiments of roof-top tents and cargo boxes, the technology may be applicable to other containers.

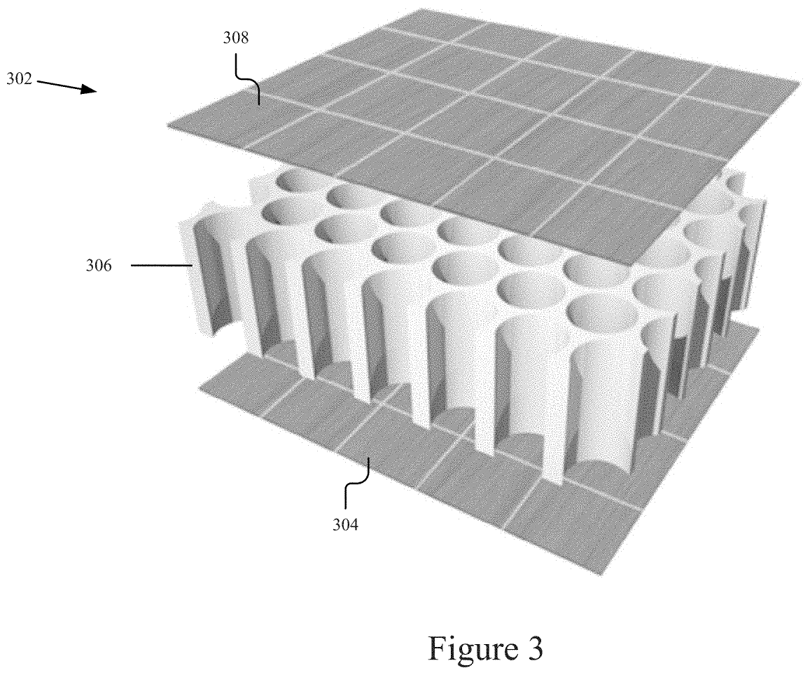

Some embodiments of the technology described herein use honeycomb construction to provide strength to the container system 102. For instance, the technology may include honeycomb panels reinforcing the bottom, top, or other portions of the container system 102 (e.g., as described below). For example, some embodiments of the technology described herein apply the honeycomb construction techniques to areas of the container system 102 to provide rigidity while allowing a lightweight overall construction of the container system 102. Example honeycomb construction is described in further detail in reference to at least FIG. 3 below. Example embodiments and construction of the container system are also described in further detail in reference to the figures below.

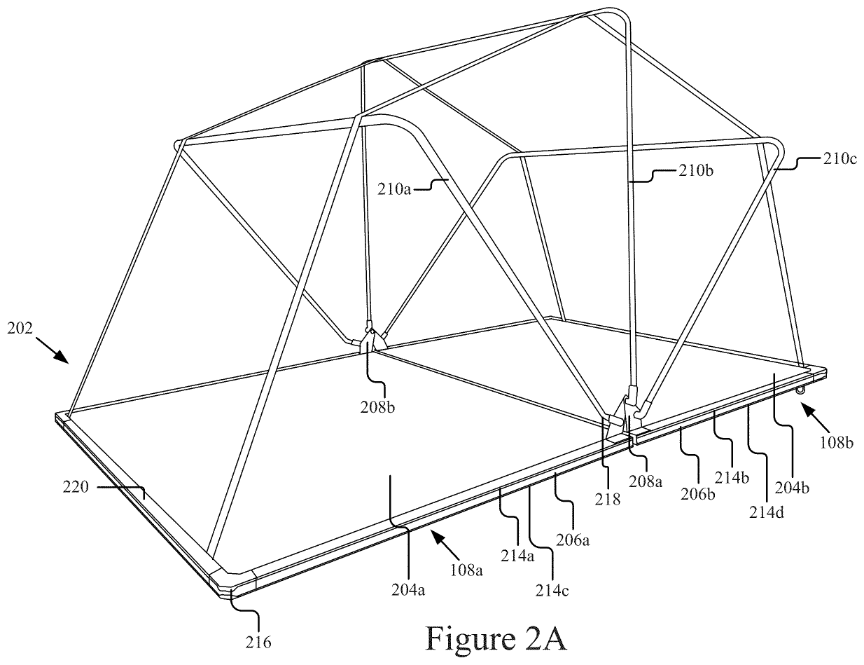

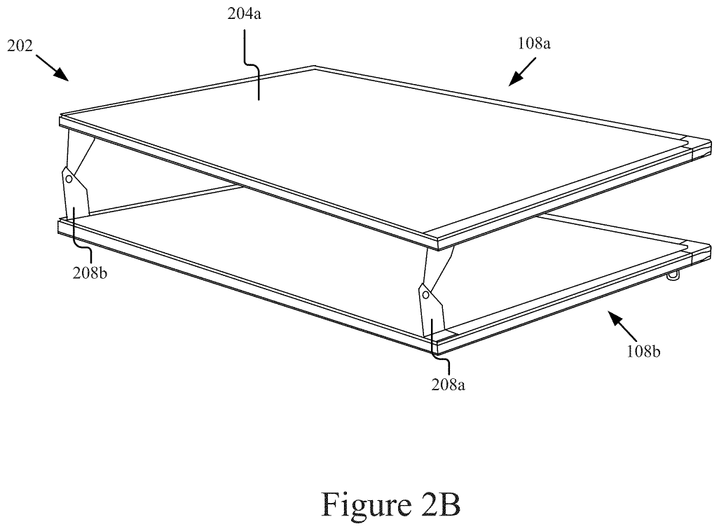

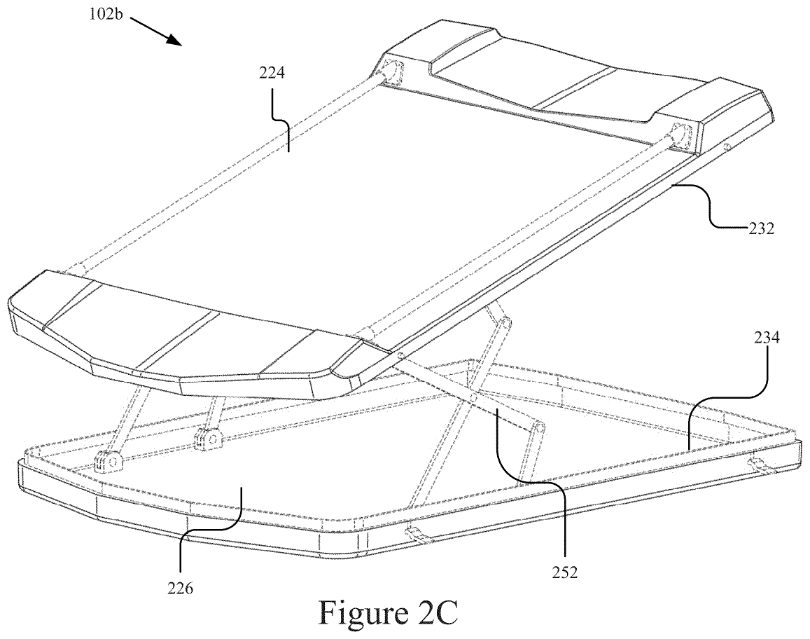

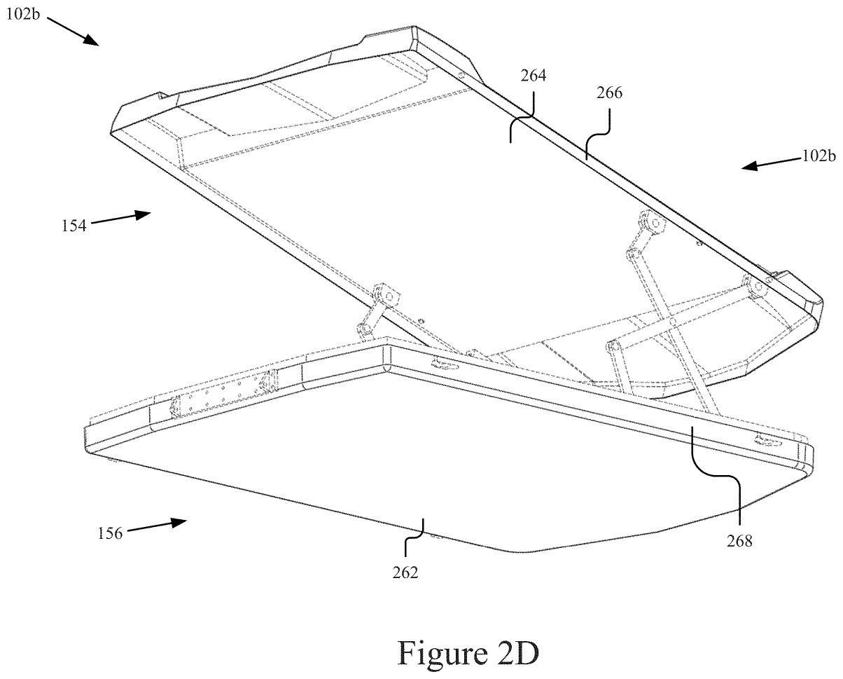

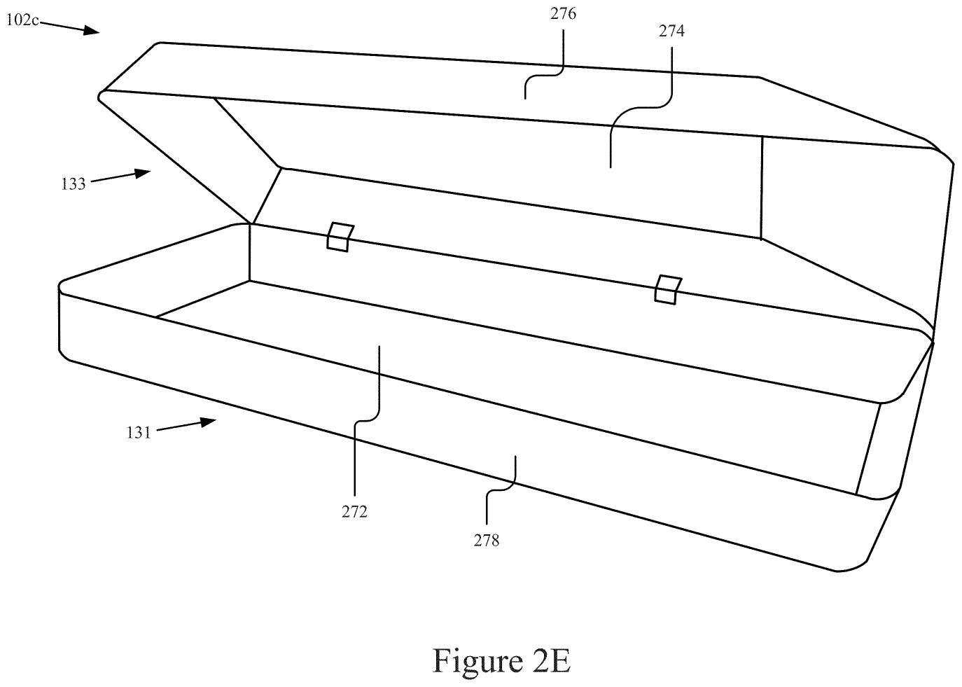

FIG. 1 is a side view 100 of an example embodiment of a container system 102a, where the container system includes a tent system (referred to herein as the container system 102a or tent system 102a) in an open position (e.g., an open position of a base system 202 of the tent system 102a is shown in FIG. 2A and a closed position is shown in FIG. 2B). In some embodiments, the tent system 102a may include a canopy 104 and one or more base members 108a and 108b (e.g., the base members 108a and 108b are components of a base system 202).

Each of the base members 108a and 108b may include a rigid surface defining a perimeter edge 206 and may be attachable to a roof rack 110 of a vehicle 112. Additionally, a base member 108 may include, or have attached thereto, a support 114 (e.g., a ladder or other vertical support) to support the base member 108. In some embodiments, the base member 108 may include a channel, zipper, or other structure along the perimeter edge which is configured to receive and retain an attachment member of the canopy. Example embodiments of the base system 202 and base members 108 are described in further detail in FIGS. 2A and 2B.

A base member 108 may include mounting hardware, such as transversely mounted rails 130 configured to rest perpendicularly across a standard vehicle roof rack 110 (although the rails 130 or other mounting hardware may have other configurations). In some embodiments, the mounting hardware may include welds, bolts, or any other hardware, which may be used to securely attach the base member 108 to the vehicle 112.

The canopy 104 may cover at least a portion of the base member 108 to form the tent roof and/or sides. In some embodiments, the canopy 104 includes a flexible membrane. In some embodiments, the canopy 104 may include a bottom pan membrane (not shown) with a membrane edge being located along the intersection between the bottom pan membrane and the flexible membrane.

The flexible membrane may be constructed of any type of flexible material, such as fabric, canvas, mesh, vinyl, nylon, polyester, etc. In particular, one of the benefits of the adaptable tent system 102 described herein is the ability to use additional, fewer, or different materials to construct the flexible membrane than are used in existing tents.

The vehicle 112 may include any vehicle capable of supporting the tent system 102, however, it should be understood that the tent system 102a may be used in other configurations. For example, although the container system 102 (e.g., the tent system 102a) is particularly beneficial for use when mounted to a vehicle 112, due to base member's 108 rigid surface, the container system 102 may be placed on the ground, or mounted to any other object (e.g., a tree, ropes, a stand, etc.).

FIG. 1B is a side view of an example rooftop tent or cargo box in a closed position. For example, the example container system 102b illustrated in FIG. 1B may be used as a rooftop tent (e.g., as illustrated in FIG. 1D) or may be used as a cargo container, for example, by excluding or removing the canopy from the container system 102. It should be noted that although a particular embodiment is shown, other embodiments, shapes, constructions, and features of the container system are possible. Example embodiments of the container system 102b, such as the bottom and top shell members of the container system 102b, are described in further detail in reference to FIG. 2C and 2D below.

As illustrated, the container system 102b may be mounted to the roof of a vehicle 112 using mounting hardware 132 for mounting the tent system 102 to the vehicle's 112 roof rails 110. In some embodiments, the mounting hardware 132 may include transverse bars or other another mechanism attached (e.g., bolted, formed within, etc.) to the bottom of a bottom shell member. For example, the mounting hardware 132 may include a transversely mounted rail, rack, clamps, straps, or other mounting hardware configured to attach the tent system 102 to vehicle roof rails 110.

As shown in the example embodiment, the container system 102b may include utility rails 148 integrated into the top shell member, although it should be noted that the integrated utility rails 148 may be attachable or detachable, etc. The utility rails 148 may support items directly or via an integrated or attachable utility/roof rack. The roof rack 148 may be bicycle, ski, or other specialized rack. For example, the roof rack 148 may include transversely mounted rails that may attach items or include attachments configured to attach items, such as bicycles, skis, or surfboards.

FIG. 1C is a side view of an example container system 102c in a closed position, for example, the container system 102c may be a rooftop cargo box for carrying cargo on top of a vehicle 112. For instance, the container system 102c may include a bottom shell member 131 and a top shell member 133. The bottom shell member 131 and the top shell member 133 may be hinged to open as a clamshell (e.g., using a piano hinge) or in the same way as the container system 102b (e.g., using a scissor hinge) described in reference to FIGS. 2C and 2D. The bottom shell member 131 and the top shell member 133 may form an interior cavity, when in the closed position, which may provide a cargo compartment in which cargo may be held, for example, for transportation on top of a vehicle 112.

The bottom shell member 131 may attach to a roof rack 110 of a vehicle 112 and may be configured to support the weight of cargo. In some embodiments, the bottom shell member 131 may be reinforced, such as using a honeycomb sandwich material (e.g., a panel), such as is described in reference to FIG. 3 and FIG. 2E.

The top shell member 133 may be constructed from a lightweight material to provide an aerodynamic profile and weather resistance to the cargo in the container system 102.

The example embodiment of the container system 102c is described in further detail in reference to FIG. 2E below.

FIG. 1D is a top perspective view of an example container system 102d in an open position and with a flexible membrane 104 attached thereto. As illustrated, the flexible membrane 104 may extend between a first section of the first perimeter edge of the bottom shell member 156 and a second section of the second perimeter edge of the top shell member 154. For example, a first membrane edge of the flexible membrane 104 may be adapted to connect to the first perimeter edge, and a second membrane edge of the flexible membrane 104 may be adapted to connect to the second perimeter edge. In some embodiments, the first membrane edge and/or the second membrane edge may include a flexible membrane fastener, such as a zipper to attach to the top or bottom shell member.

FIG. 2A is a perspective view 200 of an example embodiment of a base system 202 in an open position. The base system 202 may include one or more base members 108a and 108b. As shown, the base system 202 may include one or more rigid surfaces 204a (e.g., of a first base member 108a) and 204b (e.g., of a second base member 108b), each rigid surface 204a and 204b defining a perimeter edge 206a and 206b, respectively. The rigid surfaces 204a and 204b may be pivotally attached together using one or more hinges 208a and 208b. Further, in some embodiments, the base system 202 may include one or more poles 210a, 210b, and 210c connected to the hinges 208 or to one or both of the rigid surfaces 204a and 204b. Further, it should be noted that aspects of certain components may be described in reference to one component, but these aspects may be applicable to none, some, or all of the components. For example, features described in reference to base member 108a may be equally applicable to base member 108b and vice versa.

As illustrated in FIG. 2A, the second rigid surface 204b may be positioned on a substantially horizontal plane with the first rigid surface 204a when the tent system 102 is in an open position. Further, the second rigid surface 204b may be adapted to fold over the first rigid surface 204a when the tent system 102 is in a closed position, for example, as shown in FIG. 2B.

The rigid surfaces 204a and 204b may be solid or include some other construction, such as a flat top and an interior constructed using honeycombs, corrugations, foam, hat channels, I beams, or any other construction that allows the rigid surface to remain substantially rigid when supporting the weight of a user and/or gear inside the tent, especially when the tent system 102 is in an open position. A rigid surface 204 may be constructed of steel, aluminum, fiberglass, wood, carbon fiber, or one or more other materials that provide sufficient strength to support the weight of a user and/or gear.

In some embodiments, a rigid surface 204 may be constructed from a honeycomb sandwich material, such as is described in FIG. 3. The honeycomb sandwich material may be a panel, which can be cut to the dimensions of the rigid surface 204 and may have thicknesses and attributes (e.g., honeycomb size or composition, honeycomb thickness, skin thickness, etc.) matched to the rigidity, weight, and size constraints of the container system.

In some embodiments, the perimeter edges 206 may be attached to the rigid surface (e.g., the honeycomb panel) using adhesive, welding, tension, or fasteners, for example.

FIG. 3 illustrates an example embodiment of honeycomb sandwich material 302 (or “honeycomb material”) according to some embodiments of the technology described herein. The honeycomb material 302 may include a bottom skin 304, a honeycomb core 306, and a top skin 308.

The honeycomb core may include a plascore polypropylene honeycomb core with oriented or random chopped glass reinforced polypropylene. Depending on the embodiment, the density and cell size may be modified for strength and weight constraints. For instance, the honeycomb core may include cells or cylindrical cavities.

The bottom skin 304 and the top skin 308 may include a sheet made from plastic, aluminum, fiberglass, polypropylene, or another material. In some embodiments, one or more of the skins 304 and 308 may have a thickness sufficient to receive and retain a fastener, such as a bolt or rivet, to support sides, poles, hinges, edges, racks, rails, or other components of the container system. In some embodiments, an additional layer of skin may be placed over the bottom skin 304 and/or top skin 308 to further reinforce a fastener. For instance, a first layer of skin may be polypropylene and a second layer of the skin may be an aluminum sheet bonded or otherwise attached (e.g., via adhesive, etc.) to the first layer of skin, thereby providing additional reinforcement to fasteners used in the container system 102.

In some embodiments, such as for the purposes of the tent system 102a, the honeycomb sandwich panel 302 may have a thickness of 0.5 to 1 inches. In some embodiments, such as for the purposes of other container system embodiments (e.g., those described in reference to FIGS. 1B, 1C, and 1D), the honeycomb sandwich material may have a thickness of 0.25 to 0.5 inches. In some embodiments, the specifications for a panel may include: PP1-5.0-UV-8-30-T-N; PP1=polypropylene facings (e.g., skins) and core material; 5.0=Honeycomb Core Density; UV=UV Protection Added; 8=Cell Size in mm; 30=0-90 degree Glass—PP facing material; T=Trimmed to size; N=No Scoring; Stabilized Compressive Strength: 275 lb/in²; Thickness: 1 inch; Weight: 0.67 lb/ft²; Flexural Rigidity: 17,000 EI/inch-width. It should be understood that these specifications are provided by way of example and that other specifications are possible and contemplated herein.

Returning to FIG. 2A, each rigid surface 204 may be a rectangular prism, although other embodiments are possible. In some embodiments, each rigid surface 204 may have one or more perimeter edges 206. For example, as shown, a first rigid surface 204a has a first perimeter edge 206a and a second rigid surface 204b has a second perimeter edge 206b. In some embodiments, the rigid surface 204 has an attachment member receptacle 214 (e.g., for attaching a canopy 104) along the perimeter edge 206 (e.g., each perimeter edge 206a and 206b may define one or more channels 214a, 214b, 214c, and 214d). For example, an attachment member receptacle 214 may extend along three sides of the perimeter edge 206 of each rigid surface 204. In embodiments where the base system 202 includes two rigid surfaces 204a and 204b, the attachment member receptacle 214 may extend around four sides of the perimeter edge of the base system 202 (e.g., six total sides of the perimeter edges 206a and 206b of the two rigid surfaces 204a and 204b). In another example, the attachment member receptacle 214 may extend along four sides of the perimeter edge 206 of a rigid surface 204 in embodiments where the base system 202 includes a single rigid surface 204. It should be understood that other embodiments are possible and contemplated herein, for example, a first rigid surface 204a may define an attachment member receptacle 214a along four sides of its perimeter edge 206a, while a second rigid surface 204b may define an attachment member receptacle 214b along only three sides of its perimeter edge 206b. The rigid surfaces 204a and 204b may also include second attachment member receptacles 214c and 214d, respectively.

The hinge(s) 208 may include any type of hinge mechanism which allows the base system 202 to fold to a closed position (e.g., as in FIG. 2B), but remain substantially flat in an open position. Further the pivot point of the hinge 208 may be raised off the plane formed by the rigid surfaces 204, so that when the base system 202 is folded in a closed position, there is enough space between the rigid surfaces 204 to fit any poles 210 or other components (e.g., canopy(ies) 104, interconnecting member(s) 106, pads, etc.). Each side of the hinge 208 may be bolted to, welded to, integrally formed with, or otherwise attached to the rigid surfaces 204.

The poles 210 may be configured to form a frame that supports the canopy 104 when the canopy 104 is mounted to the base system 202. In some embodiments, the poles 210 may be integrated with or attached to the canopy 104 and attachable to receptacles in one or more base members 108.

The poles 210 may be constructed of a rigid material, such as metal (e.g., aluminum, steel, etc.), plastic, carbon fiber, etc. The cross section of each pole 210 may be circular, flat, rectangular, or any other sufficiently strong shape. In some embodiments, the poles 210 may have a three sided rectangular shape with rounded corners, as shown in FIG. 2A. In some embodiments, the poles 210 may have other shapes, such as half circles, octagons, straight poles, etc., without departing from the scope of this disclosure.

FIG. 2B is a perspective view of an example embodiment of a base system 202 in a closed position. As shown in FIG. 2B, the perspective view illustrates a base system 202 with the rigid surface 204a of a first base member 108a folded over the rigid surface 204b of a second base member 108b into a parallel plane when the tent/container system 102a is in a closed position. The base system 202 is shown pivoting about the hinges 208a and 208b.

FIG. 2C is a top perspective view of an example container system 102b in an open position and without a flexible membrane 104 attached thereto.

As illustrated in FIG. 2C, the top shell member 154 and the bottom shell member 156 may be individual components where the top shell member 154 moves away from the bottom shell member 156 when the tent system 102 is in an open position (e.g., as illustrated in FIG. 2C). As illustrated, the bottom shell member 156 includes a first rigid portion 226 that defines a first perimeter edge 234 and the top shell member 154 includes a second rigid portion 224 that defines a second perimeter edge 232. The first perimeter edge 234 and the second perimeter edge 232 may be adapted to mate when the tent system 102b is in a closed position, such that the bottom shell member 156 and the top shell member 154 define an interior cavity when the tent system 102b is in the closed position (e.g., as illustrated in FIG. 1B).

As illustrated, an articulating mechanism 252 may couple the bottom shell member 156 to the top shell member 154 and may bear against the top shell member 154 to transfer a weight of the top shell member 154 to the bottom shell member 106 and/or the roof of the vehicle 112 when the container system 102 is in the open position.

The bottom shell member 156 and/or top shell member 154 may be constructed of fiberglass sandwich, Acrylonitrile Butadiene Styrene (“ABS”), plastic, aluminum, or construction using other materials or combinations thereof. The technologies described herein provide a high strength to weight ratio, so the container system 102 may be easily transported and mounted while also being capable of supporting the weight of items attached or stored within the container system. It should be understood that other materials are possible and contemplated herein, for example, the hard shell may be constructed of other lightweight but strong materials, such as certain types of plastics, carbon fiber, aluminum, steel, etc.

In some embodiments, the bottom shell member 156 and/or top shell member 154 may use a honeycomb material, such as is described in reference to FIG. 3. For example, some embodiments of construction of the container system using honeycomb material are described in reference to FIG. 2D.

FIG. 2D is a bottom perspective view of an example container system 102b in an open position. The figure illustrates that the bottom shell member 156 may include a substantially flat bottom surface 262. In some embodiments, the bottom surface 262 may be constructed from a honeycomb panel or may have a honeycomb panel attached thereto to reinforce the bottom surface 262. In some instances, the bottom shell member 156 may be constructed from ABS material (or fiberglass or other suitable material) that may be otherwise too flexible to provide sufficient strength to support the weight of a person inside the container system (e.g., in embodiments where the container system is used or configured as a tent) or of cargo (e.g., in embodiments where the container system is used or configured as a cargo box). Accordingly, some embodiments of the technology described herein may include attaching (e.g., via adhesive, fasteners, rivets, or a combination thereof, etc.) a honeycomb sandwich panel to the bottom surface 262, either on the outside or the inside of the container system. In some instances, the bottom surface 262 of bottom shell member 156 may be constructed from a honeycomb panel with sides 268 constructed from ABS, plastic, fiberglass or other material.

Using a honeycomb sandwich construction to provide rigidity to the bottom shell member 156 is beneficial as it may provide a flat, lightweight surface not otherwise possible with corrugations, grooves, a frame, or other reinforcing construction. Further, using ABS in combination with the honeycomb reinforcement allows the container system to be lighter, more eco-friendly, and easier to manufacture than fiberglass or foam composite methods, for example, while being substantially stronger than ABS alone.

In some embodiments, the top shell member 154 may include a flat or substantially flat surface, such as the top surface 264 depicted in FIG. 2D. In some embodiments, a honeycomb sandwich panel may be attached (e.g., on the outside or the inside of the container system) to the top surface 264 or the top surface 264 may be constructed from or have integrated therewith the honeycomb sandwich panel in the same way as described in reference to the bottom shell member 156 above. For instance, the top shell member 154 may be constructed from an ABS material with a honeycomb panel attached to the top surface 264. For example, the sides 266 and other contours and components may be constructed from a suitable material that can be made in contours and may not require the strength to support a person or cargo (e.g., ABS). For instance, use of a honeycomb panel to reinforce the top shell member 154 may provide further strength for supporting items on top of the container system, such as on racks, rails, or otherwise on top of the container system 102 (whether in an open or closed position).

Although not shown in FIG. 2D, the bottom surface 262 may include mounting hardware, such as a bracket or cross members. The bracket or cross members may facilitate mounting the container system 102 to roof rails 110 of a vehicle 112. A honeycomb panel attached or integrated into the bottom surface 262 may further reinforce the coupling of the mounting hardware to the bottom shell member 156.

FIG. 2E is a perspective view of an example container system 102c (e.g., cargo box) in an open position. The figure illustrates that some embodiments of the bottom shell member 131 may include a substantially flat bottom surface 272. In some embodiments, the bottom surface 272 may be constructed from a honeycomb panel or may have a honeycomb panel attached thereto to reinforce the bottom surface 272. In some instances, the bottom shell member 131 may be constructed from ABS material (or fiberglass or other suitable material) that may be otherwise too flexible to provide sufficient strength to support the weight of cargo. Accordingly, some embodiments of the technology described herein may include attaching (e.g., via adhesive, fasteners, rivets, a combination of fasteners, etc.) a honeycomb sandwich panel to the bottom surface 272, either on the outside or the inside of the container system 102. In some instances, the bottom surface 272 of bottom shell member 131 may be constructed from a honeycomb panel with sides 278 constructed from ABS, plastic, fiberglass or other material.

In some embodiments, the top shell member 133 may include a flat or substantially flat surface, such as the top surface 274 depicted in FIG. 2E. In some embodiments, the top shell member 133 may be constructed from ABS, plastic, or another moldable material. In some embodiments, a honeycomb sandwich panel may be attached (e.g., on the outside or the inside of the container system) to the top surface 274 or the top surface 274 may be constructed from or have integrated the honeycomb sandwich panel in the same way as described in reference to FIG. 2D. For instance, the top shell member 133 may be constructed from an ABS material with a honeycomb panel attached to the ABS material on the top surface 274. For example, the sides 276 and other contours and components may be constructed from ABS and/or another suitable material that can be made in contours and may not require the strength to support a person or cargo.

In the foregoing description, for purposes of explanation, numerous specific details are set forth in order to provide a thorough understanding of the technology. It will be apparent, however, that the technology described herein can be practiced without these specific details.

Reference in the specification to “one embodiment”, “an embodiment”, “some embodiments”, or “other embodiments” means that a particular feature, structure, or characteristic described in connection with the embodiment is included in at least one embodiment of the disclosure. The appearances of the term “embodiment” or “embodiments” in various places in the specification are not necessarily all referring to the same embodiment.

In addition, it should be understood and appreciated that variations, combinations, and equivalents of the specific embodiments, embodiments, and examples may exist, are contemplated, and are encompassed hereby. The invention should therefore not be limited by the above described embodiments, embodiments, and examples, but by all embodiments, embodiments, and examples, and other equivalents within the scope and spirit of the invention as claimed.

It is to be appreciated that the Detailed Description section, and not the Brief Summary and Abstract sections, is intended to be used to interpret the claims. The Summary and Abstract sections may set forth one or more but not all exemplary embodiments of container systems as contemplated by the inventor, and thus, are not intended to limit the present embodiments and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A tent system, comprising:
a first shell member configured to mount to a roof of a vehicle, the first shell member comprising:
a honeycomb assembly, comprising:
a honeycomb core disposed between a first skin and a second skin, wherein the first and second skins are coupled to opposing faces of the honeycomb core; and
a second shell member configured to couple with the first shell member,
wherein the first and second shell members define an interior cavity in a closed configuration.

2. The tent system of claim 1, wherein the first shell member comprises acrylonitrile butadiene styrene (ABS).

3. The tent system of claim 1, wherein the honeycomb core comprises polypropylene.

4. The tent system of claim 1, wherein the honeycomb core comprises a plurality of cells.

5. The tent system of claim 1, further comprising a flexible membrane coupled between the first and second shell members.

6. The tent system of claim 1, wherein the first and second skins comprise fiberglass.

7. The tent system of claim 1, wherein the first skin comprises a plurality of layers, wherein at least one layer comprises an aluminum sheet.

8. The tent system of claim 1, wherein the honeycomb assembly comprises a thickness of 0.25 to 1 inch.

9. The tent system of claim 1, wherein the second shell member comprises a second honeycomb assembly comprising a second honeycomb core disposed between a third skin and a fourth skin, wherein the third and fourth skins are coupled to opposing faces of the second honeycomb core.

10. The tent system of claim 1, wherein the second shell member is configured to detach from the first shell member in an open configuration.

11. The tent system of claim 10, wherein the first and second shell members are hinged.

12. The tent system of claim 1, further comprising a mounting frame disposed below the honeycomb assembly and configured to reinforce coupling of the first shell member to the vehicle.

13. The tent system of claim 12, wherein the mounting frame is below a bottom surface of the first shell member.

14. A tent system, comprising:
a base configured to mount to a roof of a vehicle, the base comprising:
a platform with a perimeter edge, wherein the platform comprises a honeycomb assembly, the honeycomb assembly comprising:
a honeycomb core disposed between a first skin and a second skin, wherein the first and second skins are coupled to opposing faces of the honeycomb core; and
a tent canopy coupled to the perimeter edge of the platform.

15. The tent system of claim 14, wherein the honeycomb core comprises polypropylene.

16. The tent system of claim 14, wherein the first and second skins comprise fiberglass.

17. The tent system of claim 14, wherein the platform comprises a first rigid surface and a second rigid surface, wherein the first and second rigid surfaces are coupled to each other by a hinge.

18. The tent system of claim 14, further comprising a tent frame coupled to the base and configured to support the tent canopy.

19. A container system, comprising:
a first shell member configured to mount to a roof of a vehicle, the first shell member comprising:
a honeycomb assembly, comprising:
a honeycomb core disposed between a first skin and a second skin, wherein the first and second skins are coupled to opposing faces of the honeycomb core; and
a second shell member configured to couple to the first shell member, the second shell member comprising:
a second honeycomb assembly, comprising:
a second honeycomb core disposed between a third skin and a fourth skin, wherein the third and fourth skins are coupled to opposing faces of the second honeycomb core;
wherein the first and second shell members define an interior cavity in a closed configuration, and
wherein the first and second shell members comprise acrylonitrile butadiene styrene (ABS).

20. The container system of claim 19, wherein:
the first and second honeycomb cores comprise polypropylene; and the first, second, third, and fourth skins comprise fiberglass.
